(19) United States
(12) Patent Application Publication
(10) Pub. No.: US 2002/0191253 A1
(43) Pub. Date: Dec. 19, 2002

(54) Method and apparatus for remote control

(75) Inventors: Chien-Na Yang, Tainan City (TW); Che-Ming Liao, Taipei City (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Dah Yang Toy Industrial Co., Ltd.

(21) Appl. No.: 10/211,106

(22) Filed: Aug. 1, 2002

Related U.S. Application Data
(63) Continuation-in-part of application No. 09/697,408, filed on Oct. 26, 2000.

(30) Foreign Application Priority Data
May 27, 2002 (TW) 091111161

(51) Int. Cl. H04B 10/00

(52) U.S. Cl. 359/142; 359/154

(57) ABSTRACT

In a method for remote control using a plurality of infrared transmitters, each of which is associated with a respective infrared receiver, each of the infrared transmitters and the respective infrared receiver are configured with a codeword unique thereto. Different priorities are assigned to the infrared transmitters. Control signal transmission for one of the infrared transmitters is enabled only when no control signal from another one of the infrared transmitters is received thereby within a predetermined time period having a duration that corresponds to the assigned priority. Each of the infrared receivers is configured to execute an intended operation upon receipt of the control signal transmitted by the infrared transmitter having the same codeword. An apparatus implementing the method is also disclosed.

### CROSS-REFERENCE TO RELATED APPLICATIONS

This application is also a continuation-in-part (CIP) of commonly assigned U.S. patent application Ser. No. 09/697,408, filed on Oct. 26, 2000, the entire disclosure of which is incorporated herein by reference.

This application claims priority of Taiwanese application no. 091111161, filed on May 27, 2002.

### BACKGROUND OF THE INVENTION

1. Field of the Invention

The invention relates to a method and apparatus for remote control, more particularly to a method and apparatus for remote control using a plurality of infrared transmitters and a plurality of infrared receivers.

2. Description of the Related Art

Due to a relatively wide bandwidth, different carrier frequencies, such as 27.1 MHz, 27.2 MHz, 27.3 MHz, . . . , etc., can be assigned to a plurality of radio frequency signals such that it is possible to wirelessly transmit the radio frequency signals simultaneously with minimum interference. However, when transmitting a plurality of infrared signals, signal interference easily occurs due to relatively narrow bandwidths, and relatively low carrier frequencies, such as 38.1 KHz and 38.2 KHz.

In co-pending U.S. patent application Ser. No. 09/697,408, filed by the applicant on Oct. 26, 2000, there is disclosed an apparatus for remote control that includes a plurality of infrared transmitters and a plurality of infrared receivers corresponding to the infrared transmitters. Each of the infrared transmitters includes a password setting unit operable so as to set a codeword that is unique thereto, and a manually operable control unit operable so as to generate a desired operation signal. One of the infrared transmitters is configured to periodically transmit a start command, which is transmitted at the onset of a predetermined time period, and is further configured to detect the desired operation signal from the control unit and to transmit an operation command upon detection of the desired operation signal after the predetermined time period. Each of the remaining infrared transmitters is configured to detect reception of the start command at the onset of a predetermined delay that is a fraction of the predetermined time period. The fraction of the predetermined time period varies among the remaining infrared transmitters according to the codeword that was assigned thereto. Each of the remaining infrared transmitters is further configured to detect the desired operation signal from the control unit and to transmit an operation command upon detection of the desired operation signal after the predetermined delay.

### SUMMARY OF THE INVENTION

The object of the present invention is to provide a method and apparatus for remote control using a plurality of infrared transmitters and a plurality of infrared receivers with minimal interference.

According to one aspect of the present invention, there is provided a method for remote control using a plurality of infrared transmitters and a plurality of infrared receivers, each of which is associated with a respective one of the infrared transmitters. The method includes the steps of:

(a) configuring each of the infrared transmitters and the respective one of the infrared receivers with a codeword that is unique thereto;

(b) assigning different priorities to the infrared transmitters;

(c) enabling control signal transmission for one of the infrared transmitters only when no control signal from another one of the infrared transmitters is received thereby within a predetermined time period having a duration that corresponds to the assigned priority; and

(d) configuring each of the infrared receivers to execute an intended operation upon receipt of the control signal transmitted by said one of the infrared transmitters having the same codeword.

According to another aspect of the present invention, an apparatus for remote control includes a plurality of infrared transmitters and a plurality of infrared receivers, each of which is associated with a respective one of the infrared transmitters.

Each of the infrared transmitters is configured with a codeword that is unique thereto and includes a first receiving unit, a first transmitting unit, a manually operable control unit operable so as to generate a desired control signal, and a first processing unit connected to the first receiving unit, the first transmitting unit, and the manually operable control unit. The infrared transmitters are assigned with different priorities. The first processing unit is configured to detect the desired control signal from the control unit and to enable the first transmitting unit to transmit the control signal only when no control signal from another one of the infrared transmitters is received by the first processing unit from the first receiving unit within a predetermined time period having a duration that corresponds to the priority assigned to the infrared transmitter.

Each of the infrared receivers is configured with a codeword corresponding to that of the respective one of the infrared transmitters and includes a second receiving unit, a drive unit operable so as to execute an intended operation, and a second processing unit connected to the second receiving unit and the drive unit. The second processing unit of each of the infrared receivers is configured so as to operate the drive unit to execute the intended operation upon receipt by the second receiving unit of the control signal transmitted by the respective one of the infrared transmitters.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic electrical circuit diagram showing an infrared transmitter of the preferred embodiment of an apparatus for remote control according to this invention;

FIG. 2 is a schematic electrical circuit diagram showing an infrared receiver of the preferred embodiment;

FIG. 3 is a flow chart illustrating how the infrared transmitters transmit a control signal in accordance with a method for remote control of the preferred embodiment;

FIG. 4 is a flow chart illustrating how the infrared receivers execute an intended operation in accordance with the method of the preferred embodiment; and

FIG. 5 is a table showing an exemplary set of priority protocols utilized in the preferred embodiment.

### DETAILED DESCRIPTION OF THE PREFERRED EMBODIMENT

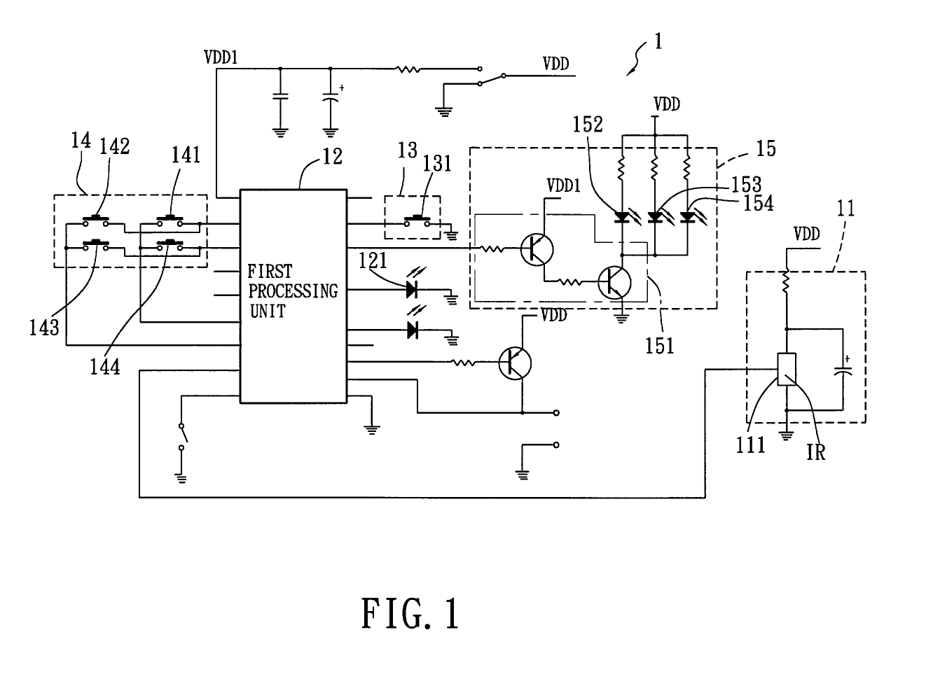

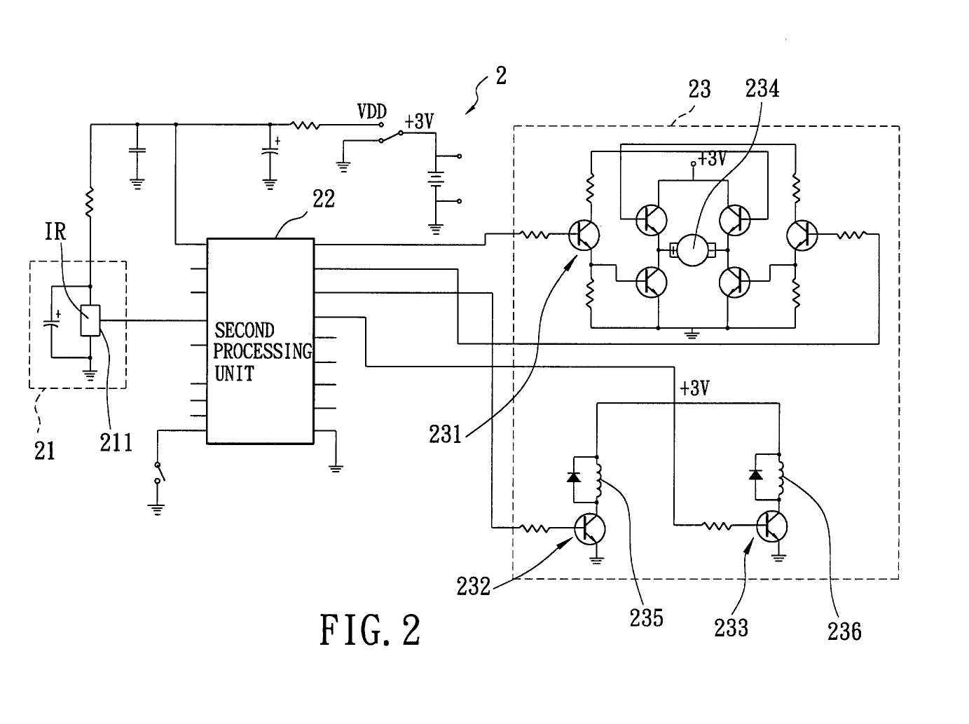

Referring to FIGS. 1 and 2, according to the preferred embodiment of this invention, an apparatus for remote control includes a plurality of infrared transmitters 1 (see FIG. 1) and a plurality of infrared receivers 2 (see FIG. 2), each of which is associated with a respective one of the infrared transmitters 1.

As shown in FIG. 1, each of the infrared transmitters 1 includes a first receiving unit 11, a password setting unit 13, a first transmitting unit 15, a manually operable control unit 14, and a first processing unit 12.

The first receiving unit 11 includes an infrared receiver module 111 that is capable of receiving an infrared signal and that provides the infrared signal received thereby to the first processing unit 12 for decoding.

The password setting unit 13 is operable so as to set a codeword that is unique thereto. In this embodiment, the password setting unit 13 includes a single key 131 repeatedly operable by a number of times corresponding to the codeword. The codeword corresponds to an identification code (ID) of the infrared transmitter 1 and is a four-bit number such that the codeword can be set to “0000”, “0001”, “0010”, . . . , or “1111”.

The first processing unit 12 is connected to the first receiving unit 11, the password setting unit 13, the first transmitting unit 15, and the manually operable control unit 14. The first processing unit 12 is further connected to a pair of light emitting diodes 121.

When configuring the codeword for the infrared transmitter 1, the number of times the key 131 of the password setting unit 13 is repeatedly operated will be detected by the first processing unit 12. One second after codeword configuration, the first processing unit 12 will drive the diodes 121 to flash the codeword at a frequency of 2 HZ frequency. Half a second later, the same action is repeated for confirmation. During the codeword flashing action, the first processing unit 12 will activate the first transmitting unit 15 to transmit the codeword twice for configuring the corresponding infrared receiver 2.

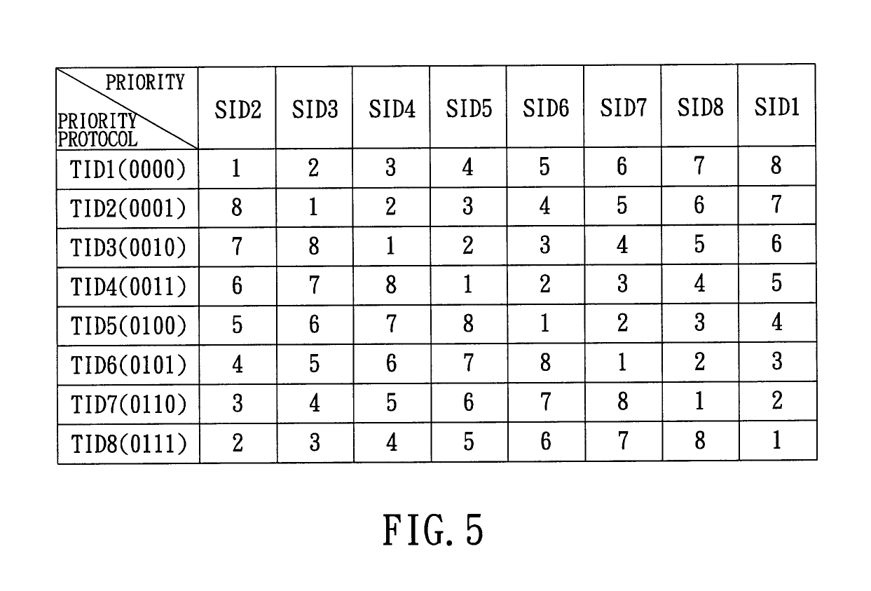

The first processing unit 12 has a number of priority protocols for the infrared transmitters 1 defined therein. Different ones of the priority protocols have different assigned priorities for the infrared transmitters 1. Referring to FIG. 5, in an exemplary remote control apparatus according to this invention, there are eight infrared transmitters 1, and a corresponding number of priority protocols are defined in each first processing unit 12, i.e. TID1, TDI2, . . . , TID8. Each priority protocol includes eight different priorities SID1, SID2, . . . , SID8 assigned respectively to the infrared transmitters 1, wherein the lower the priority value, the higher will be the priority order for the infrared transmitter 1 in the corresponding priority protocol. When the infrared transmitter 1 is activated, a default priority protocol, e.g. the priority protocol TID1, is first selected. The priority protocols are subsequently dynamically selected, which will be described in greater detail hereinafter.

The manually operable control unit 14 is operable so as to generate a desired control signal. In this embodiment, the control unit 14 includes four button switches 141, 142, 143 and 144 associated with a respective control signal that is sent to the first processing unit 12 when operated. After encoding the desired control signal generated by the control unit 14, together with the codeword set via the password setting unit 13, the first processing unit 12 enables the first transmitting unit 15 for control signal transmission only when no control signal from another one of the infrared transmitters 1 is received thereby via the first receiving unit 11 within a predetermined time period having a duration that corresponds to the assigned priority. This will be described in greater detail hereinafter.

The first transmitting unit 15 includes a driver circuit 151 connected to and controlled by the first processing unit 12, and three infrared light emitting diodes 152, 153 and 154 connected to and driven by the driver circuit 151. In this embodiment, the three infrared light emitting diodes 152, 153 and 154 permit infrared signals to be transmitted with a wider transmission angle so as to reduce the presence of dead corners during transmission.

As shown in FIG. 2, each of the infrared receivers 2 includes a second receiving unit 21, a drive unit 23, and a second processing unit 22. In this embodiment, each of the infrared receivers 2 can be incorporated in a remote control toy car body (not shown).

The second receiving unit 21 includes an infrared receiver module 211 capable of receiving and providing infrared signals to the second processing unit 22 for decoding.

After the infrared receiver 2 is activated, when the codeword transmitted by the first transmitting unit 15 of the corresponding infrared transmitter 1 is received, the codeword is provided to the second processing unit 22 for configuring the codeword of the infrared receiver 2. After codeword configuration, all infrared signals received by the second receiving unit 21 of the infrared receiver 2 will be provided to the second processing unit 22 for codeword validation and for drive unit activation.

The drive unit 23 is operable so as to execute an intended operation. In this embodiment, the drive unit 23 includes a plurality of drive circuits 231, 232, 233 for driving a motor 234 and left and right coils 235, 236 respectively to enable the car body to generate an intended action, such as forward or backward movement via the motor 234, and left or right turning movement of front wheels via the coils 235, 236. In this embodiment, the controlling relationship of the motor 234 and the left and right coils 235, 236 with the button switches 141, 142, 143 and 144 can be set as follows: the button switch 141 of the infrared transmitter 1 is assigned with the control signal that enables the motor 234 to move the car body in a forward direction; the button switch 142 of the infrared transmitter 1 is assigned with the control signal that enables the motor 234 to move the car body in a backward direction; the button switch 143 of the infrared transmitter 1 is assigned with the control signal that excites the left coil 235 for left turning movement of the front wheels; and the button switch 144 of the infrared transmitter 1 is assigned with the control signal that excites the right coil 236 for right turning movement of the front wheels.

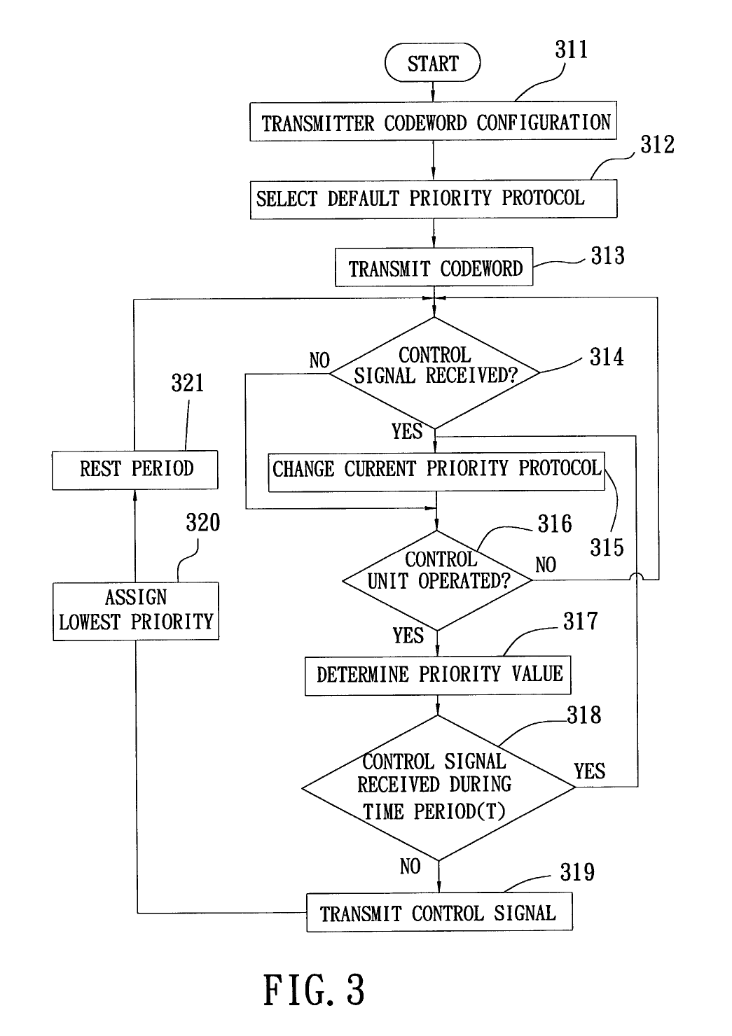

Referring to FIG. 3, there is shown a flow chart to illustrate how the infrared transmitters 1 transmit control signals according to a method for remote control of the preferred embodiment. At step 311, when the infrared transmitter 1 is activated, codeword configuration is performed as described in the foregoing. At step 312, the default priority protocol, e.g. TID1, is selected although any one of TID1˜TID8 may be set as the default priority protocol in practice. Taking the infrared transmitter 1 assigned with priority SID1 as an example, the priority value is “8” when the priority protocol TID1 is selected. In step 313, the first processing unit 12 will activate the first transmitting unit 15 to transmit the codeword twice so as to configure the corresponding infrared receiver 2. At step 314, the first processing unit 12 detects whether the first receiving unit 11 received a control signal. If none, the flow proceeds to step 316. Otherwise, the flow advances to step 315. At step 315, one of the priority protocols is selected by the first processing unit 12 as the current priority protocol according to a latest one of the infrared transmitters 1 to have performed control signal transmission. Taking the infrared transmitter 1 with the codeword “0000” as an example, when a control signal is received from the infrared transmitter 1 with the codeword “0011”, the priority protocol selected will be TID4 (see FIG. 5) at step 315. At step 316, the first processing unit 12 detects whether the manually operable control unit 14 connected thereto is operated. In the affirmative, the flow advances to step 317. Otherwise, the flow goes back to step 314. At step 317, the first processing unit 12 determines the priority value based on the current priority protocol. In the case of the infrared transmitter 1 with the codeword “0000”, i.e. assigned priority is SID1, when the current priority protocol is TID4, the corresponding priority value is “5”. The flow then advances to step 318. At step 318, the first processing unit 12 detects whether a control signal from any of the other infrared transmitters 1 was received within a predetermined time period (T) having a duration that corresponds to the assigned priority. In this embodiment, the predetermined time period (T) is decided according to the following formula: T=[priority value*1 msec]. Therefore, when the priority value is 5, the predetermined time period will be equal to 5 msec. When no control signal was received from the other infrared transmitters 1 in step 318, the flow advances to step 319. Otherwise, the flow goes back to step 315. Due to the presence of step 318, transmission priority among the infrared transmitters 1 can be enforced. Particularly, the higher the priority value assigned to the infrared transmitter 1, the longer will be the predetermined time period (T) such that those infrared transmitters 1 with the lower priority value will be able to transmit a control signal without interference. For instance, under the priority protocol TID4, only those infrared transmitters 1 with priority values ranging from 1 to 4 (i.e. assigned priorities of SID5 to SID8) can precede control signal transmission by the infrared transmitter 1 with the codeword “0000” (i.e. assigned priority is SID1).

To ensure that the infrared transmitters 1 have fair chances of gaining highest priority, when one of the infrared transmitters 1 completes control signal transmission, the method contemplates advancing the priorities for the other infrared transmitters 1. For instance, if the infrared transmitter 1 with the assigned priority SID1 receives a control signal from the infrared transmitter 1 with the codeword “0100” at step 318, the flow then goes to step 315 to change the current priority protocol from TID4 to TID5. Since the priority value associated with SID1 in the priority protocol TID5 is “4”, the transmission priority for the infrared transmitter 1 associated with SID1 is advanced from “5” to “4”.

At step 319, a desired control signal is transmitted. The transmission time is proportional to the number of bits to be transmitted. In this embodiment, a transmitted control signal comprises seventeen bits b0˜b16, wherein b0 is defined as a start bit with a value of 1; b1˜b4 are allotted for the codeword (maximum of sixteen values); b5˜b12 are allotted for the command associated with the control signal (maximum of 256 values); and b13˜b16 are added bits, such as parity check bits, to complement b0˜b12. Assuming that one bit takes one msec to transmit, the transmission time for the 17-bit control signal is 17 msec. After transmission, the flow advances to step 320.

At step 320, lowest priority (in this embodiment, priority value “8”) is assigned to the infrared transmitter 1 after it has performed control signal transmission. Thereafter, at step 321, the infrared transmitter 1 rests for a predetermined rest period, such as 100 msec. It is noted that each infrared transmitter 1 requires 17 msec to transmit a control signal. Thus, eight infrared transmitters 1 will require 136 msec to transmit a respective control signal continuously in sequence. During the rest period after transmission of a control signal by the infrared transmitter 1, the infrared signals received by the infrared transmitter 1 are most likely to be noise signals, and there is no need for the first processing unit 12 to perform detection and processing. After the rest period, the flow proceeds back to step 314.

In summary, when the infrared transmitters 1 are used for remote control operation, the control signals are scheduled for transmission in accordance with the priority values for SID1˜SID8 under the current priority protocol. When any one of the infrared transmitters 1 transmits a control signal, the other infrared transmitters 1 will dynamically change the current priority protocol in the manner described beforehand. Since the priority values change with the priority protocol, the infrared transmitters 1 will have fair chances of gaining higher priority for control signal transmission. Therefore, simultaneous transmissions of control signals can be avoided by the different infrared transmitters 1 to prevent interference. Furthermore, because operation of a button switch of the control unit 14 will persist more than 100 msec, the aforesaid rest period also takes into consideration the user's acceptable response time to ensure continuity of the remote control operation.

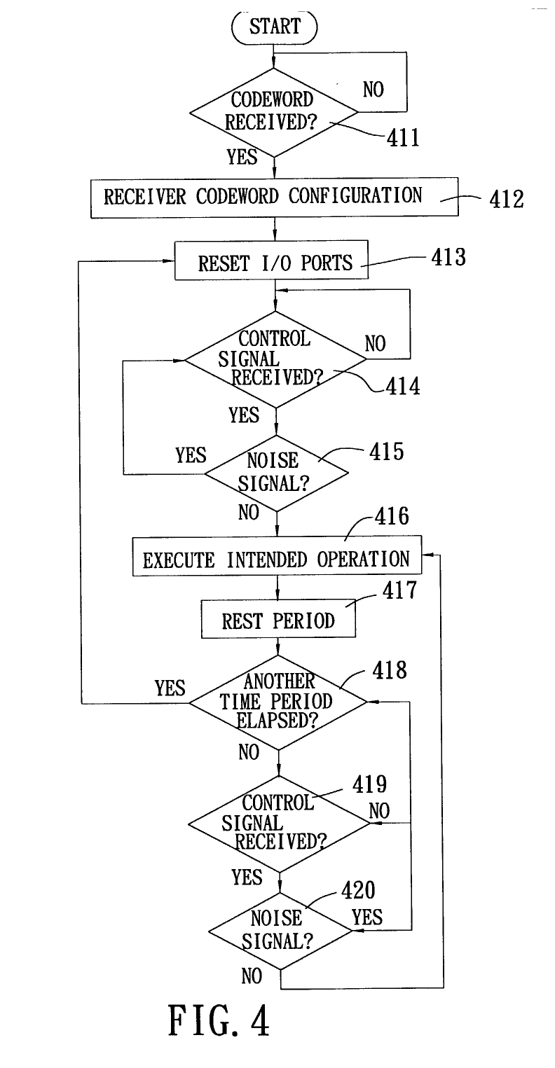

Referring to FIG. 4, there is shown a flow chart to illustrate how the infrared receivers 2 execute an intended operation according to the method of the preferred embodiment. At step 411, when the infrared receiver 2 is activated, it will first detect the receipt of a codeword. At step 412, the second receiving unit 21 provides the codeword received thereby to the second processing unit 22 to configure the codeword of the infrared receiver 2. Thereafter, at step 413, I/O ports of the second processing unit 22 are reset. Next, at step 414, the second processing unit 22 detects whether the second receiving unit 21 received a control signal. When the second receiving unit 21 has yet to receive a control signal, the flow goes back to step 414. Otherwise, the flow advances to step 415, where the second processing unit 22 determines whether the control signal is a noise signal. When the codeword involved in the control signal is different from that assigned to the infrared receiver 2, the control signal is deemed to be a noise signal. When the control signal is a noise signal, the flow goes back to step 414. Otherwise, the flow advances to flow 416, where the drive unit 24 executes an intended operation associated with the control signal, and then to step 417. At step 417, the infrared receiver 2 rests for a predetermined rest period, such as 140 msec. The rest period is generally the time interval between step 314 and step 321 of the corresponding infrared transmitter 1, and any signal received before this period elapses will be deemed as a noise signal. From step 417, the flow advances to step 418. At the step 418, it is determined if another 140 msec time period has elapsed. If yes, the flow goes back to step 413. Otherwise, the flow advances to step 419. At step 419, the second processing unit 22 detects whether a control signal has been received. It is noted that each infrared receiver 2 can receive the control signal transmitted by the respective infrared transmitter 1 having the same codeword during the second 140 msec time period. If it is determined in step 419 that a control signal has been received, the flow goes to step 420. Otherwise, the flow goes back to step 418. In step 420, it is determined if the control signal is a noise signal. If yes, the flow goes back to step 418. Otherwise, the flow proceeds back to step 416 to execute the intended operation.

In summary, by means of the codeword configuration provided in the infrared transmitters 1 and the infrared receivers 2, and the protocol as described in FIG. 3, only one infrared transmitter 1 can transmit a control signal to the corresponding infrared receiver 2 having the same codeword at any time. Therefore, the method and apparatus of this invention permit remote control using a plurality of infrared transmitters and a plurality of infrared receivers with minimal interference. The object of the invention is thus met.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method for remote control using a plurality of infrared transmitters and a plurality of infrared receivers, each of which is associated with a respective one of the infrared transmitters, said method comprising the steps of:
(a) configuring each of the infrared transmitters and the respective one of the infrared receivers with a codeword that is unique thereto;
(b) assigning different priorities to the infrared transmitters;
(c) enabling control signal transmission for one of the infrared transmitters only when no control signal from another one of the infrared transmitters is received thereby within a predetermined time period having a duration that corresponds to the assigned priority; and
(d) configuring each of the infrared receivers to execute an intended operation upon receipt of the control signal transmitted by said one of the infrared transmitters having the same codeword.

2. The method as claimed in claim 1, wherein step (a) includes the sub-steps of:
configuring one of the infrared transmitters with the corresponding codeword; and
enabling said one of the infrared transmitters to transmit the corresponding codeword for configuring the respective one of the infrared receivers.

3. The method as claimed in claim 1, wherein step (b) includes the sub-steps of:
defining a number of priority protocols for the infrared transmitters, different ones of the priority protocols having different assigned priorities for the infrared transmitters; and
dynamically selecting one of the priority protocols according to a latest one of the infrared transmitters to have performed control signal transmission.

4. The method as claimed in claim 3, wherein the priority protocols correspond in number to the infrared transmitters.

5. The method as claimed in claim 1, further comprising, after step (c), the step of assigning lowest priority to a latest one of the infrared transmitters to have performed control signal transmission.

6. An apparatus for remote control, comprising a plurality of infrared transmitters and a plurality of infrared receivers, each of which is associated with a respective one of said infrared transmitters,
wherein each of said infrared transmitters is configured with a codeword that is unique thereto and includes a first receiving unit, a first transmitting unit, a manually operable control unit operable so as to generate a desired control signal, and a first processing unit connected to said first receiving unit, said first transmitting unit, and said manually operable control unit,
said infrared transmitters being assigned with different priorities,
said first processing unit being configured to detect the desired control signal from said control unit and to enable said first transmitting unit to transmit the control signal only when no control signal from another one of said infrared transmitters is received by said first processing unit from said first receiving unit within a predetermined time period having a duration that corresponds to the priority assigned to said infrared transmitter;
each of said infrared receivers being configured with a codeword corresponding to that of the respective one of said infrared transmitters and including a second receiving unit, a drive unit operable so as to execute an intended operation, and a second processing unit connected to said second receiving unit and said drive unit, said second processing unit of each of said infrared receivers being configured so as to operate said drive unit to execute the intended operation upon receipt by said second receiving unit of the control signal transmitted by the respective one of said infrared transmitters.

7. The apparatus of claim 6, wherein each of said infrared transmitters further includes a password setting unit connected to said first processing unit and operable so as to set the codeword therefor.

8. The apparatus of claim 7, wherein said password setting unit includes a single key repeatedly operable by a number of times corresponding to the codeword.

9. The apparatus of claim 6, wherein said first processing unit of each of said infrared transmitters has a number of priority protocols for said infrared transmitters defined therein, different ones of the priority protocols having different assigned priorities for said infrared transmitters, said first processing unit of each of said infrared transmitters dynamically selecting one of the priority protocols according to a latest one of said infrared transmitters to have performed control signal transmission.

10. An apparatus for remote control, comprising an infrared transmitter and an infrared receiver associated with said infrared transmitter,
wherein said infrared transmitter is configured with a codeword that is unique to said apparatus and includes a first receiving unit, a first transmitting unit, a manually operable control unit operable so as to generate a desired control signal, and a first processing unit connected to said first receiving unit, said first transmitting unit, and said manually operable control unit,
said first processing unit being configured to detect the desired control signal from said control unit and to enable said first transmitting unit to transmit the control signal only when no control signal from said infrared transmitter of another said apparatus is received by said first processing unit from said first receiving unit within a predetermined time period having a duration that corresponds to a priority assigned to said infrared transmitter;
said infrared receiver being configured with a codeword corresponding to that of said infrared transmitter and including a second receiving unit, a drive unit operable so as to execute an intended operation, and a second processing unit connected to said second receiving unit and said drive unit, said second processing unit being configured so as to operate said drive unit to execute the intended operation upon receipt by said second receiving unit of the control signal transmitted by said infrared transmitter.
